(19) United States
(12) Patent Application Publication
(10) Pub. No.: US 2013/0061492 A1
(43) Pub. Date: Mar. 14, 2013

(54) SUPERCRITICAL DRYING METHOD AND SUPERCRITICAL DRYING APPARATUS FOR SEMICONDUCTOR SUBSTRATE

(71) Applicants: Hisashi OKUCHI, Yokohama-shi (JP); Hidekazu HAYASHI, Yokohama-shi (JP); Linan JI, Shanghai (CN); Yohei SATO, Yokohama-shi (JP); Hiroshi TOMITA, Yokohama-shi (JP)

(72) Inventors: Hisashi OKUCHI, Yokohama-shi (JP); Hidekazu HAYASHI, Yokohama-shi (JP); Linan JI, Shanghai (CN); Yohei SATO, Yokohama-shi (JP); Hiroshi TOMITA, Yokohama-shi (JP)

(21) Appl. No.: 13/423,374

(22) Filed: Mar. 19, 2012

(30) Foreign Application Priority Data
Sep. 14, 2011 (JP) 2011-200569

(51) Int. Cl. F26B 5/04

(52) U.S. Cl. 34/402; 34/72

(57) ABSTRACT

According to one embodiment, a supercritical drying apparatus comprises a chamber being hermetically sealable and configured to store a semiconductor substrate, a heater configured to heat an inner side of the chamber, a supply unit configured to supply carbon dioxide to the chamber, a discharge unit configured to discharge carbon dioxide from the chamber, and a rotation unit configured to rotate the chamber by an angle equal to or greater than 90 degrees and equal to or smaller than 180 degrees with respect to the horizontal direction.

### CROSS REFERENCE TO RELATED APPLICATION

This application is based upon and claims benefit of priority from the Japanese Patent Application No. 2011-200569, filed on Sep. 14, 2011, the entire contents of which are incorporated herein by reference.

### FIELD

Embodiments described herein relate generally to a supercritical drying apparatus and a supercritical drying method.

### BACKGROUND

A process of manufacturing a semiconductor device includes a variety of processes such as a lithography process, an etching process, and an ion implantation process. Before moving to the next process after passing through each process, remnants or residual impurities remaining on the surface of a wafer are removed by cleaning and drying treatments to purify the surface of a wafer.

For example, in the wafer cleaning treatment performed after an etching process, a cleaning liquid is supplied to the surface of a wafer first, and pure water is then supplied for rinse treatment. After the rinse treatment, a drying treatment is performed to remove the pure water remaining on the surface of the wafer to thereby dry the wafer.

Examples of known drying method include spin drying which removes water remaining on the wafer after rinsing with pure water by spinning, IPA drying which dries the wafer by substituting the pure water remaining on the wafer after rinsing with pure water using isopropyl alcohol (IPA), and the like. However, a problem with this method is that a pattern formed on the wafer is likely to collapse due to a surface tension of the pure water and the IPA.

In order to solve such a problem, supercritical drying has been proposed, in which the surface tension becomes zero. For example, a wafer of which the surface is wet with IPA is delivered to a supercritical chamber, and the IPA on the wafer is gradually extracted by a supercritical CO₂ fluid by filling the inside of the chamber with supercritical carbon dioxide (supercritical CO₂ fluid). In addition, the IPA concentration in the chamber is gradually reduced along with the supercritical CO₂ in which the IPA is extracted by continuously introducing the supercritical CO₂ into the chamber. Then, the introduction of the supercritical CO₂ stops, and the supercritical CO₂ fluid is discharged out of the chamber. Due to the decreased pressure during the discharge operation, the supercritical CO₂ transitions to a gaseous phase at the point below the critical pressure. The discharging is continuously performed until the inside of the chamber is recovered to a normal pressure, and the wafer is finally withdrawn.

However, when the inside space of the chamber is depressurized so that the carbon dioxide can undergo phase transition from the supercritical state to gas, there is a problem in that the IPA being dissolved in the supercritical CO₂ fluid and hence remaining in the chamber agglomerates and is adsorbed back onto the wafer, leaving a drying trace on the wafer, so that particles would be attached to the surface of the water.

### BRIEF DESCRIPTION OF THE DRAWINGS

FIG. 1 is a phase diagram illustrating a relation of pressure, temperature, and phase states of a substance;

FIG. 2 is a schematic configuration diagram illustrating a supercritical drying system according to a first embodiment of the present invention;

FIGS. 3A and 3B are diagrams illustrating an exemplary pipe and a coupling method thereof;

FIGS. 4A to 4E are diagrams illustrating rotation of a chamber;

FIG. 5 is a flowchart illustrating a supercritical drying method according to the first embodiment;

FIG. 6 is a phase diagram of carbon dioxide and IPA;

FIGS. 7A and 7B are diagrams illustrating a surface of the semiconductor substrate after the supercritical drying treatment in a case where rotation of the chamber is performed and is not performed;

FIG. 8 is a schematic configuration diagram illustrating a supercritical drying system according to a second embodiment of the present invention;

FIGS. 9A and 9B are schematic configuration diagrams illustrating a casing for storing and delivering a semiconductor substrate according to the second embodiment;

FIGS. 10A and 10B are diagrams illustrating a method of storing the semiconductor substrate in the casing;

FIGS. 11A and 11B are schematic configuration diagrams illustrating a delivery unit according to the second embodiment;

FIGS. 12A to 12D are diagrams illustrating a method of storing the semiconductor substrate in a chamber; and

FIG. 13 is a flowchart illustrating a supercritical drying method according to the second embodiment.

### DETAILED DESCRIPTION

According to one embodiment, a supercritical drying apparatus comprises a chamber being hermetically sealable and configured to store a semiconductor substrate, a heater configured to heat an inner side of the chamber, a supply unit configured to supply carbon dioxide to the chamber, a discharge unit configured to discharge carbon dioxide from the chamber, and a rotation unit configured to rotate the chamber by an angle equal to or greater than 90 degrees and equal to or smaller than 180 degrees with respect to the horizontal direction.

Hereafter, a receiver and a receiving method according to the present invention will be described more specifically with reference to the drawings.

### First Embodiment

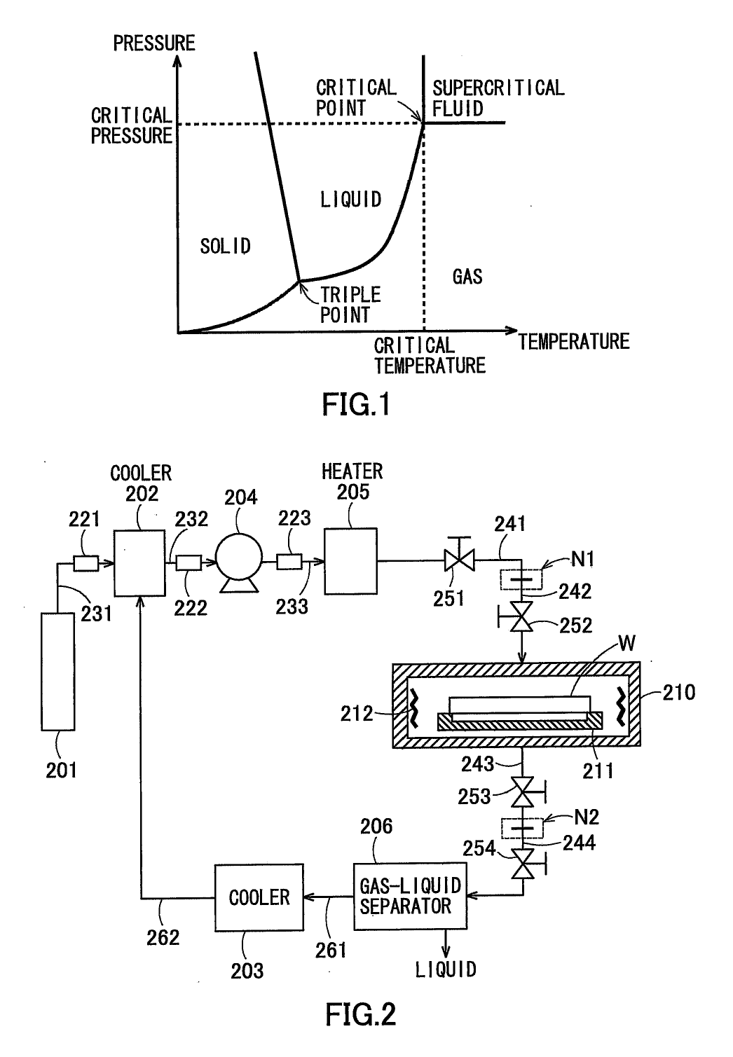

First, supercritical drying will be described. FIG. 1 is a phase diagram illustrating a relation of pressure, temperature, and phase states of a substance. Functional substance of the supercritical fluid used in the supercritical drying has three existence states, called three states of substance, including a gaseous phase (gas), a liquid phase (liquid), and a solid phase (solid).

As illustrated in FIG. 1, the three phases described above can be distinguished by a vapor pressure curve (gaseous phase equilibrium line) indicating a boundary between gaseous and liquid phases, a sublimation curve indicating a boundary between gaseous and solid phases, and a dissolution curve indicating a boundary between solid and liquid phases. A point at which these three phases are overlapped is called a triple point. If the vapor pressure curve is elongated from this triple point to a higher-pressure and higher-temperature side, the phase approaches a critical point at which both the gaseous phase and the liquid phase exist. At this critical point, densities are equal between the gaseous phase and the liquid phase, and thus, an interface of a vapor-liquid coexistence state is removed.

In a higher-temperature and higher-pressure state beyond the critical point, there is no distinction between gaseous and liquid phases, and a substance becomes a supercritical fluid. The supercritical fluid is a fluid compressed in a high density at the critical temperature or higher. The supercritical fluid is analogous to gas in that a spreading force of solvent molecules is dominant. Meanwhile, the supercritical fluid is analogous to liquid in that influence of a cohesive force of molecules is not negligible. Therefore, it has a property of dissolving various substances.

In addition, the supercritical fluid is highly infiltrative, compared to liquid, and capable of easily infiltrating into microstructures.

In addition, the supercritical fluid can be dried without destructing the microstructure by directly transitioning to the gaseous phase from the supercritical state so as not to form an interface between gas and liquid, that is, so as not to apply a capillary force (surface tension). The supercritical drying uses such a supercritical state of the supercritical fluid to dry a substrate.

A supercritical fluid used in such supercritical drying may include, for example, a substance selected from a group consisting of carbon dioxide, ethanol, methanol, propanol, butanol, methane, ethane, propane, water, ammonia, ethylene, or fluoromethane.

Particularly, carbon dioxide can be easily treated at a relatively low pressure and a relatively low temperature because it has a critical temperature of 31.1° C. and a critical pressure of 7.37 MPa. In the present embodiment, it is assumed that the supercritical drying is performed using carbon dioxide.

FIG. 2 illustrates a schematic configuration of the supercritical drying system according to a first embodiment of the invention. The supercritical drying system includes a cylinder 201, coolers 202 and 203, a boost pump 204, a heater 205, a gas-liquid separator 206, and a chamber 210.

The cylinder 201 reserves liquid state carbon dioxide. The boost pump 204 boosts a pressure of carbon dioxide output from the cylinder 201 and discharges it. The carbon dioxide output from the cylinder 201 is supplied to the cooler 202 through the pipe 231, cooled, and then, supplied to the boost pump 204 through the pipe 232.

The boost pump 204 boosts a pressure of the carbon dioxide and discharges it. For example, the boost pump 204 increases a pressure of carbon dioxide to a critical pressure or higher. The carbon dioxide discharged from the boost pump 204 is supplied to the heater 205 through the pipe 233. The heater 205 increases a temperature of (applies heat to) carbon dioxide to the critical temperature or higher.

Each of the pipes 231 to 233 is provided with filters 221 to 223 for removing particles.

The carbon dioxide discharged from the heater 205 is supplied to the chamber 210 through a supply unit including pipes 241 and 242. The pipe. 241 is provided with a valve 251, and the pipe 242 is provided with a valve 252. The pipes 241 and 242 are formed of, for example, steel use stainless (SUS).

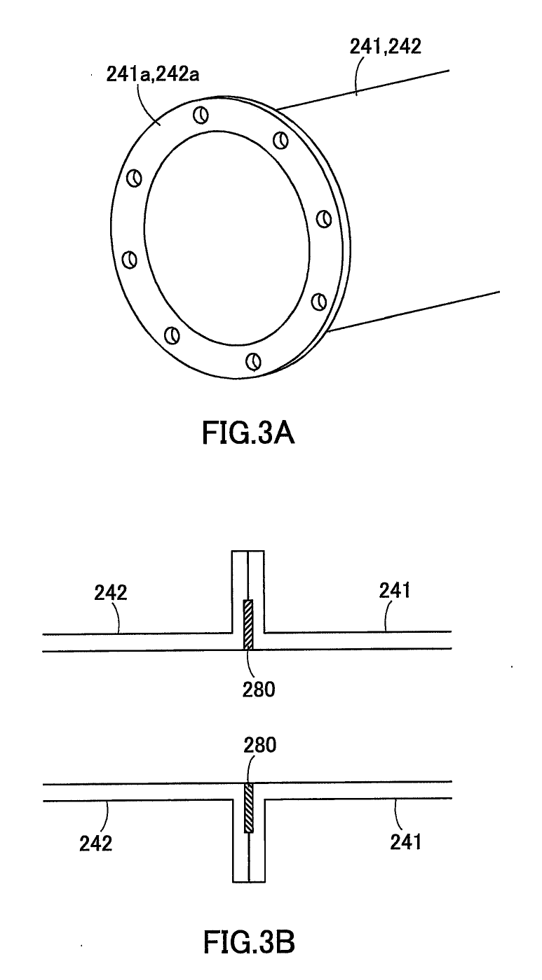

One end of the pipe 241 is connected to the heater 205, and one end of the pipe 242 is connected to the chamber 210. In addition, the other end of the pipe 241 and the other end of the pipe 242 are demountably connected to each other using a connector N1. FIG. 3A illustrates an exemplary end section of the pipe 241 or 242, and FIG. 3B illustrates an exemplary connection state between the pipes 241 and 242. As illustrated in FIGS. 3A and 3B, the flange 241a of the pipe 241 and the flange 242a of the pipe 242 are connected to each other by interposing a gasket 280 using bolts (not illustrated). The gasket 280 may be a metal gasket formed of, for example, aluminum and the like. The pipes 241 and 242 can be demounted (separated) by removing the bolts. A locking mechanism which connects the pipe 241 with the pipe 242 without using the bolts may be used. For example, the locking mechanism is based on a piston mechanism.

The chamber 210 illustrated in FIG. 2 is made of SUS and is a high-pressure casing hermetically sealable to assure a predetermined pressure resistance. The chamber 210 has a stage 211 and a heater 212. The stage 211 is a flat plate having a ring shape for holding the treatment target substrate W. The heater 212 is configured to adjust a temperature within the chamber 210. The heater 212 may be provided in the outer periphery of the chamber 210.

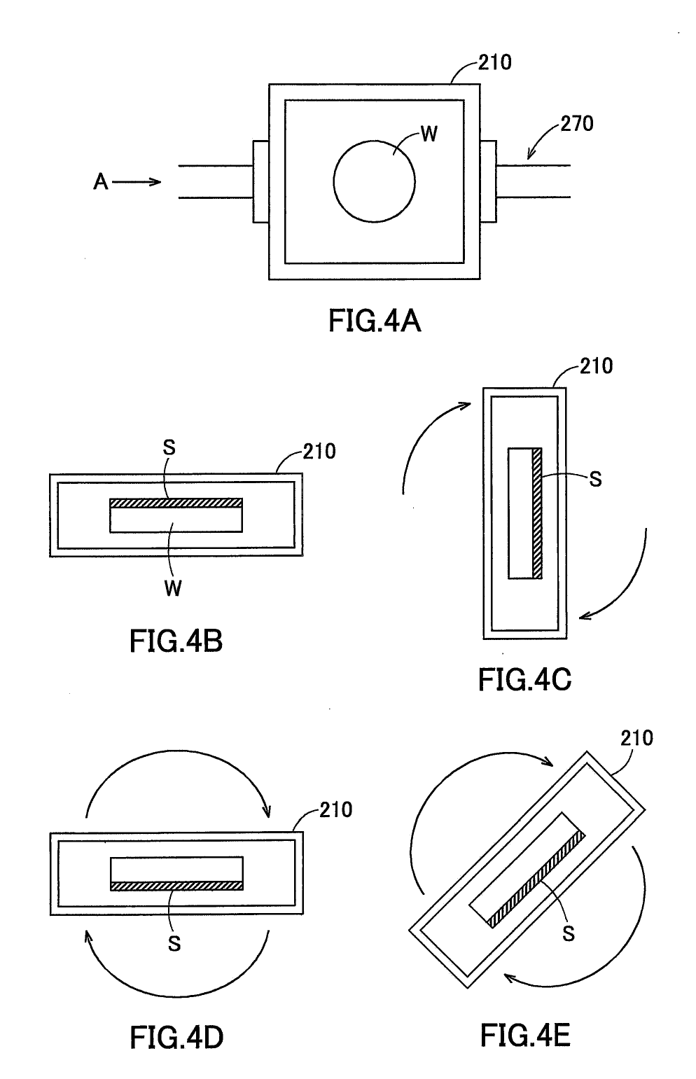

FIG. 4A is a horizontally cross-sectional view illustrating the chamber 210. The chamber 210 is configured to rotate by the rotation unit 270. FIGS. 4B to 4E are vertically cross-sectional view illustrating the chamber 210 as seen from the A direction of FIG. 4A. In FIGS. 4B to 4E, the rotation unit 270 is not illustrated. When the chamber 210 is rotated, connection between the pipes 241 and 242 and connection between the pipes 243 and 244 described below are released in advance. The pipes 242 and 243 connected to the chamber 210 are rotated along with the chamber 210.

FIG. 4B illustrates a state that the chamber 210 does not rotate by the rotation unit 270, in which the treatment target substrate W within the chamber 210 is arranged such that the surface S having a pattern is oriented to an upward direction.

FIG. 4C illustrates a state that the rotation unit 270 rotates the chamber 210 by 90 degrees with respect to the horizontal direction, in which the pattern surface S of the treatment target substrate W is oriented to a lateral direction.

FIG. 4D illustrates a state that the rotation unit 270 rotates the chamber 210 by 180 degrees with respect to the horizontal direction, in which the pattern surface S of the treatment target substrate W is oriented to a downward direction. In other words, the rear surface where the pattern of the treatment target substrate W is not formed is oriented to an upward direction.

FIG. 4E illustrates a state that the rotation unit 270 rotates the chamber 210 by about 135 degrees with respect to the horizontal direction, in which the pattern surface S of the treatment target substrate W is oriented to an obliquely downward direction. In other words, the rear surface of the treatment target substrate W is oriented to an obliquely upward direction.

In this manner, the rotation unit 270 rotates the chamber 210 by a predetermined angle equal to or greater than 90 degrees and equal to or smaller than 180 degrees with respect to the horizontal direction such that the pattern surface S of the treatment target substrate W in the chamber 210 is oriented to a lateral direction, an obliquely downward direction, or a downward direction. The chamber 210 is held at a predetermined angle. Here, the predetermined angle refers to a certain angle or an angle range equal to or greater than 90 degrees and equal to or smaller than 180 degrees with respect to the horizontal direction. That is, if the chamber 210 is rotated by an angle equal to or greater than 90 degrees and equal to or smaller than 180 degrees with respect to the horizontal direction, it can be said that the chamber 210 Is held at a predetermined angle even when the chamber 210 is not held at a constant angle. The operation of the rotation unit 270 is controlled by a controller (not illustrated).

As illustrated in FIG. 2, the gas or the supercritical fluid within the chamber 210 is discharged through a discharge unit including pipes 243 and 244 and delivered to the gas-liquid separator 206. The pipes 243 and 244 are provided with valves 253 and 254, respectively. The pressure in the chamber 210 can be adjusted by the apertures of the valves 253 and 254. The supercritical fluid is changed to gas in the downstream side from the valve 254 of the pipe 244.

One end of the pipe 243 is connected to the chamber 210, and one end of the pipe 244 is connected to the gas-liquid separator 206. In addition, the other end of the pipe 243 and the other end of the pipe 244 are demountably connected to each other using a connector N2. The structure and the method of connecting pipes 243 and 244 are similar to those of the pipes 241 and 242, and description thereof will not be repeated.

The gas-liquid separator 206 separates gas and liquid. For example, if carbon dioxide having a supercritical state by dissolving alcohol is discharged from the chamber 210, the gas-liquid separator 206 separates the liquid alcohol and the gaseous carbon dioxide. The separated alcohol can be reused.

The gaseous carbon dioxide discharged from the gas-liquid separator 206 is supplied to the cooler 203 through the pipe 261. The cooler 203 cools down the carbon dioxide to be a liquid state and discharges it to the cooler 202 through the pipe 262. The carbon dioxide discharged from the cooler 203 is also supplied to the boost pump 204. In this configuration, carbon dioxide cyclically can be used.

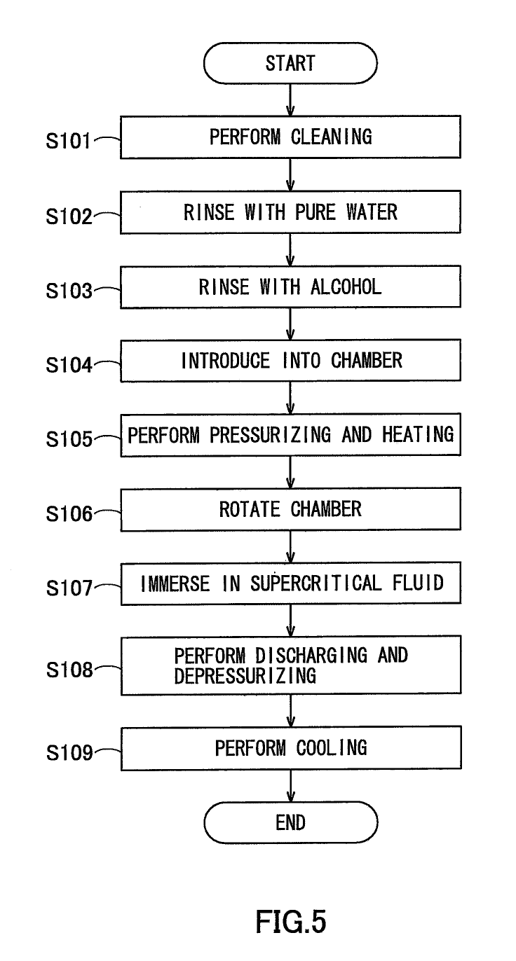

FIG. 5 is a flowchart illustrating a method of drying and cleaning a semiconductor substrate according to an embodiment of the invention.

(Step S101) A treatment target semiconductor substrate is introduced into a cleaning chamber (not illustrated). A micro pattern is formed on the surface of the semiconductor substrate. In addition, a chemical solution is supplied to the surface of the semiconductor substrate to perform cleaning. The chemical solution may include, for example, sulfuric acid, hydrofluoric acid, hydrochloric acid, hydrogen peroxide, and the like.

Here, the cleaning includes a treatment for exfoliating a resist from the semiconductor substrate, removing particles or metal impurities, etching a film formed on the substrate, or the like.

(Step S102) A pure water rinse treatment is performed by supplying pure water to the surface of the semiconductor substrate and rinsing the chemical solution remaining on the surface of the semiconductor substrate with pure water.

(Step S103) An alcohol rinse treatment is performed by supplying alcohol to the surface of the semiconductor substrate and substituting the pure water remaining on the surface of the semiconductor substrate with pure water. Alcohol that can be dissolved into (easily substituted with) both the pure water and the supercritical carbon dioxide fluid is used. In the present embodiment, it is assumed that isopropyl alcohol (IPA) is used.

(Step S104) The semiconductor substrate is withdrawn from the cleaning chamber while the surface is wet with IPA to prevent natural drying, introduced into the chamber 210 of the supercritical drying system of FIG. 2, and fixed to the stage 211. After the semiconductor substrate is fixed, the chamber 210 is hermetically sealed.

(Step S105) The carbon dioxide gas within the cylinder 201 is pressurized and heated using the boost pump 204 and the heater 205 and supplied to the inside of the chamber 210 through pipes 241 and 242. In this case, the valves 253 and 254 are closed, and the valves 251 and 252 are opened.

If the pressure and temperature within the chamber 210 are equal to or higher than the critical pressure and temperature of carbon dioxide, carbon dioxide within the chamber 210 becomes supercritical fluid (supercritical state).

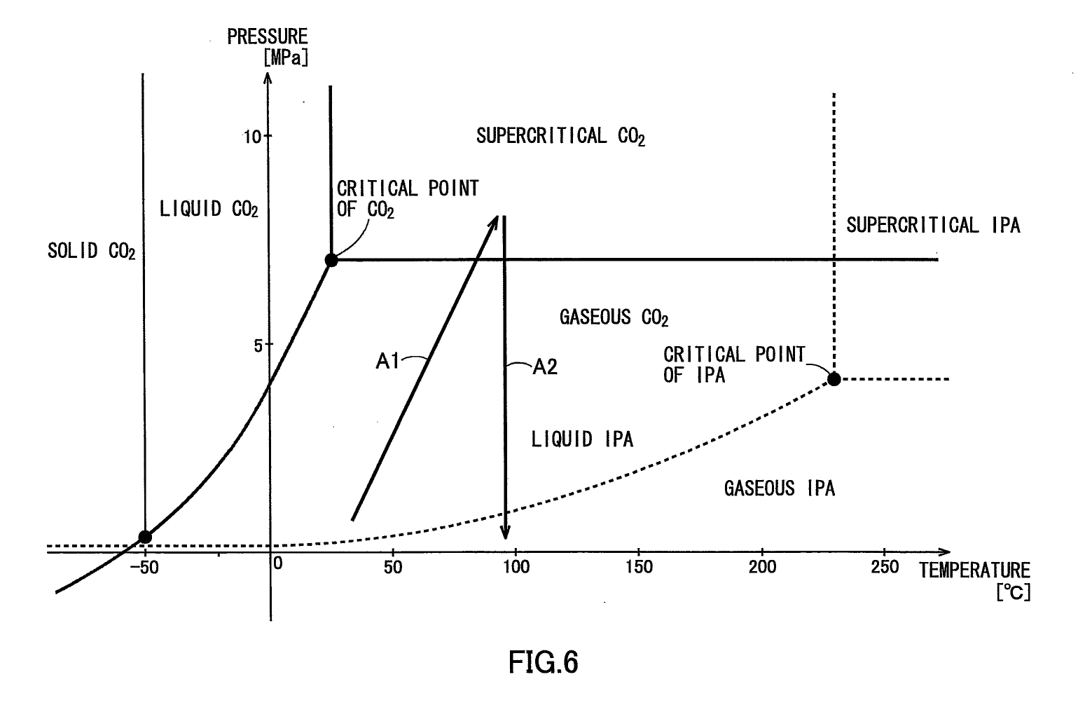

FIG. 6 is a phase diagram illustrating a relation between pressure, temperature, and phase states for each of carbon dioxide and IPA. In FIG. 6, the solid line denotes carbon dioxide, and the dotted line denotes IPA. The change of carbon dioxide within the chamber 210 in this step is denoted by the arrow A1 in FIG. 6.

(Step S106) The valves 251 and 252 are closed, and connection between the pipes 241 and 242 in the connector N1 is released. In addition, while the valves 253 and 254 are closed, connection between the pipes 243 and 244 in the connector N2 is released. In addition, the controller controls the rotation unit 270 such that the chamber 210 is rotated by a predetermined angle equal to or greater than 90 degrees and equal to or smaller than 180 degrees with respect to the horizontal direction, and the chamber 210 is held at a predetermined angle. As a result, the surface of the semiconductor substrate within the chamber 210 is oriented to a lateral direction, an obliquely downward direction, or a downward direction.

After the chamber 210 is rotated, the pipes 241 and 242 are connected again, and the pipes 243 and 244 are connected again.

In addition, supply of carbon dioxide to the chamber 210 is resumed by opening the valves 251 and 252.

(Step S107) The semiconductor substrate is immersed in the supercritical CO₂ fluid for a predetermined time, for example, 20 minutes. As a result, the IPA on the semiconductor substrate is dissolved into the supercritical CO₂ fluid, and the IPA is removed from the semiconductor substrate. In other words, the IPA on the surface (pattern surface) of the semiconductor substrate is substituted with the supercritical CO₂ fluid.

In this case, the valves 253 and 254 are opened slightly while the supercritical CO₂ fluid is supplied to the inside of the chamber 210 through the pipes 241 and 242 so that the supercritical CO₂ fluid where the IPA has been dissolved is slowly discharged from the chamber 210 through the pipes 243 and 244.

(Step S108) While the chamber 210 is held at a predetermined angle, the valves 253 and 254 are opened with a large aperture to discharge inner gas and reduce the pressure in the chamber 210 (refer to the arrow A2 in FIG. 6). As shown in the arrow A2 of FIG. 6, due to the depressurization in the chamber 210, the carbon dioxide within the chamber 210 is changed from the supercritical state to the gaseous state.

In this case, the liquid IPA remaining in the chamber while being dissolved into the supercritical CO₂ fluid is agglomerated and falls down to the semiconductor substrate. However, in step S106, the chamber 210 is rotated such that the surface of the semiconductor substrate is oriented to a lateral direction, an obliquely downward direction, or a downward direction. For this reason, most of the agglomerated liquid IPA falls down to the rear surface of the semiconductor substrate, and is rarely adsorbed to the surface. Therefore, it is possible to prevent particles from being attached to the surface of the semiconductor substrate.

(Step S109) The semiconductor substrate is delivered to a cooling chamber (not illustrated) to perform cooling.

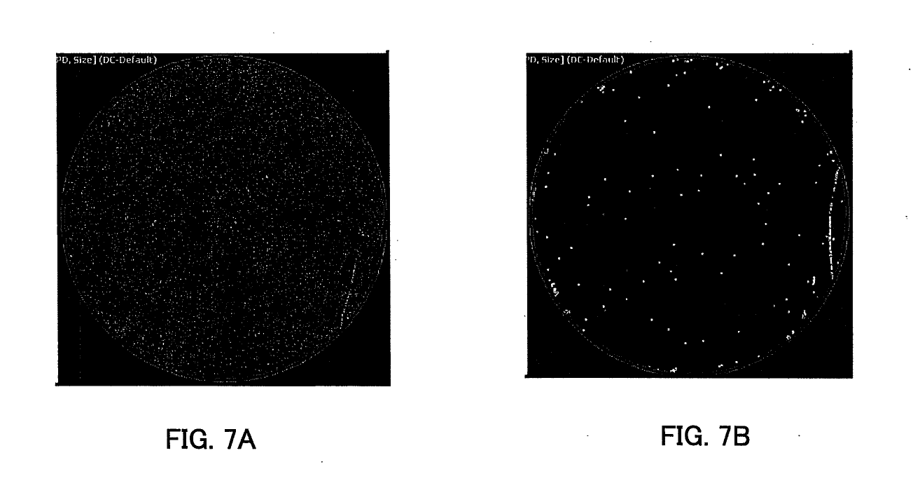

FIGS. 7A and 7B illustrate experimental results in a case where the process of rotating the chamber 210 in step S106 is not performed and in a case where the chamber 210 is rotated by 180 degrees. The size of the semiconductor substrate used in this experiment is set to φ300 mm.

FIG. 7A illustrates the surface of the semiconductor substrate after the supercritical drying treatment is performed in a case where the process of rotating the chamber 210 is not performed. The number of particles having a size equal to or larger than 38 nm exceeds about 10,000.

Meanwhile, FIG. 7B illustrates the surface of the semiconductor substrate after the supercritical drying treatment is performed in a case where the chamber 210 is rotated by 180 degrees. The number of particles having a size equal to or larger than 38 nm results in about 1,000. It is recognized that it is possible to prevent the liquid IPA from falling down to the surface of the semiconductor substrate and remarkably reduce the number of particles by rotating the chamber 210 and orienting the surface of the semiconductor substrate to a downward direction.

In this manner, according to the present embodiment, the chamber 210 is rotated by an angle equal to or greater than 90 degrees and equal to or smaller than 180 degrees with respect to the horizontal direction, and the surface of the semiconductor substrate is oriented to a lateral direction, an obliquely downward direction, or a downward direction. Therefore, even when the IPA remaining in the chamber while being dissolved Into the supercritical CO₂ fluid is agglomerated and falls down to the semiconductor substrate through the discharge and depressurizing in the chamber 210, most of the IPA is attached to the rear surface of the semiconductor substrate. Therefore, it is possible to reduce the number of particles attached to the surface (pattern surface) of the semiconductor substrate.

In the embodiment described above, a metal flexible tube may be used as the pipes 242 and 243. In this case, it is possible to rotate the chamber 210 while the pipes 242 and 243 are connected to the chamber 210. In addition, since it is not necessary to disconnect the pipes 241 and 244, it is possible to remove the valves 252 and 253.

In the present embodiment, the chamber 210 may be rotated at any moment before the discharge and depressurizing of step S108 after the carbon dioxide within the chamber 210 is changed to the supercritical fluid (supercritical state). For example, the chamber 210 may be rotated after the semiconductor substrate is immersed in the supercritical CO₂ fluid for a predetermined time. Alternatively, the chamber 210 may be rotated if the concentration of IPA discharged along with carbon dioxide from the chamber 210 in step S107 is equal to or lower than a predetermined value.

### Second Embodiment

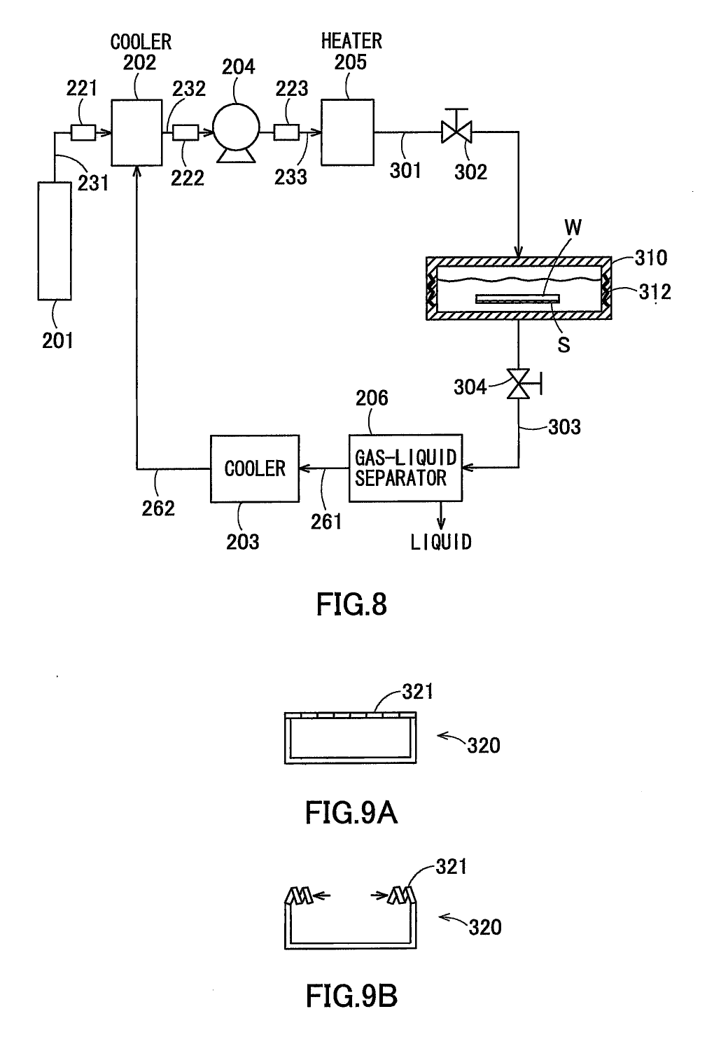

FIG. 8 illustrates a schematic configuration of the supercritical drying system according to a second embodiment of the invention. The present embodiment is different from the first embodiment of FIG. 2 in that rotation of the chamber 210 is not performed. In FIG. 8, like reference numerals denote like elements as in the first embodiment of FIG. 2, and description thereof will not be repeated.

As shown in FIG. 8, the carbon dioxide discharged from the heater 205 is supplied to the chamber 310 through a supply unit including the pipe 301 and the valve 302. The valve 302 is configured to adjust the amount of carbon dioxide supplied to the chamber 310.

The chamber 310 is made of SUS and is a high-pressure casing hermetically sealable with a predetermined pressure resistance. The chamber 310 has a heater 212 capable of heating the inside of the chamber 310. In addition, the chamber 310 includes a holding unit (not illustrated) for holding the treatment target substrate W. As shown in FIG. 8, the chamber 310 holds the treatment target substrate W by orienting the pattern surface S of the treatment target substrate W to a vertically downward direction.

The gas or supercritical fluid within the chamber 310 is discharged through the discharge unit including the pipe 303 and the valve 304 and is supplied to the gas-liquid separator 206. The pressure within the chamber 310 can be adjusted by an aperture of the valve 304. The supercritical fluid is changed to the gas in the downstream side from the valve 304 of the pipe 303.

A method of delivering the treatment target substrate W to the chamber 310 will be described with reference to FIGS. 9 to 12.

The casing 320 shown in FIGS. 9A and 9B is used to deliver the treatment target substrate W. The casing 320 is provided with an openable cover 321. FIG. 9A illustrates a state that the cover 321 is closed, and FIG. 9B illustrates a state that the cover 321 is opened. The open/close state of the cover 321 is controlled by a controller (not illustrated). The casing 320 is formed of, for example, a simple fluoroplastic substance or metal such as SUS coated by fluoroplastic.

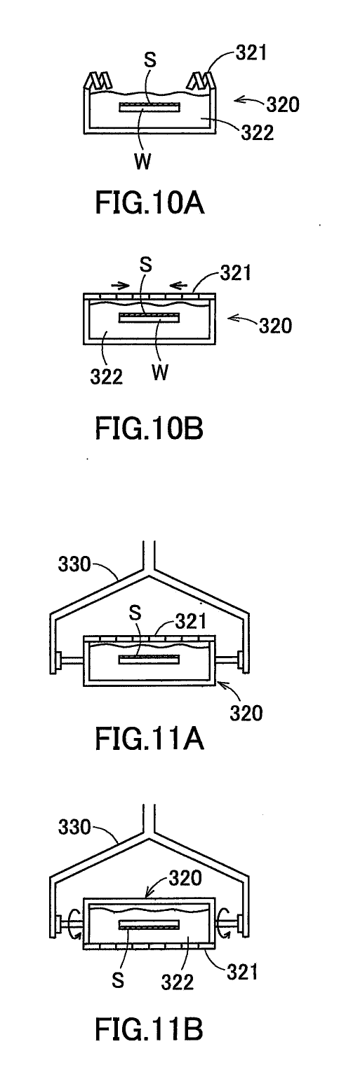

As illustrated in FIG. 10A, alcohol 322 is reserved in the casing 320, and a delivery unit (not illustrated) delivers the treatment target substrate W which has been subjected to the cleaning to the inside of the casing 320 in a state that the pattern surface S is wet with alcohol. Here, the alcohol 322 reserved in the casing 320 is similar to the alcohol used to wet the pattern surface S. The delivery unit delivers the treatment target substrate W such that the pattern surface S is oriented to a vertically upward direction.

If the treatment target substrate W is held by the holding unit (not illustrated) within the casing 320 while the treatment target substrate W is immersed in alcohol 322, the cover 321 is closed as illustrated in FIG. 10B.

The casing 320 which houses the treatment target substrate W is held rotatably by the delivery unit 330 as illustrated in FIG. 11A. The rotational operation of the casing 320 is controlled by a controller (not illustrated). The casing 320 is reversed as illustrated in FIG. 11B when the delivery unit 330 holds the casing 320. As a result, the pattern surface S of the treatment target substrate W is oriented to a vertically downward direction. In this case, since the cover 321 of the casing 320 is closed, the treatment target substrate W is immersed in alcohol 322 within the casing 320.

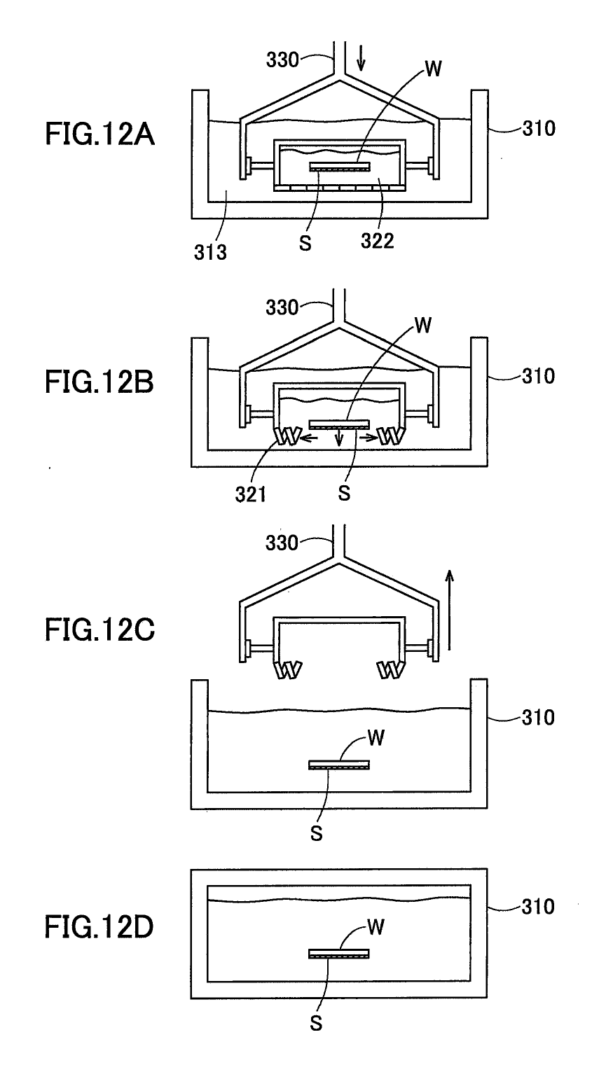

The delivery unit 330 delivers the reversed casing 320 to the chamber 310. As illustrated in FIG. 12A, the chamber 310 reserves alcohol 313 similar to the alcohol 322 within the casing 320. The delivery unit 330 immerses at least a part of the casing 320 (the cover 322) in alcohol 313.

Then, as illustrated in FIG. 12B, the cover 321 is opened, and the treatment target substrate W is withdrawn to the outside of the casing 320. For example, as the cover 321 is opened, a grip delivery unit (not illustrated) provided in the chamber 310 grips the treatment target substrate W within the casing 320, extracts the treatment target substrate W from the casing 320, and holds it in the chamber 310. The pattern surface S of the treatment target substrate W is oriented to a vertically downward direction.

As illustrated in FIG. 12C, the delivery unit 330 is moved from the inside of the chamber 310, and the chamber 310 is closed as illustrated in FIG. 12D. In this manner, while keeping the pattern surface S of the treatment target substrate W to be wet with alcohol, the treatment target substrate W can be arranged within the chamber 310 by orienting the pattern surface S to a vertically downward direction.

Although alcohol is reserved in the entire chamber 310 for description purposes in FIGS. 12A to 12D, an inner casing for reserving alcohol within the chamber 310 may be provided, and the treatment target substrate W may be immersed in alcohol of the inner casing.

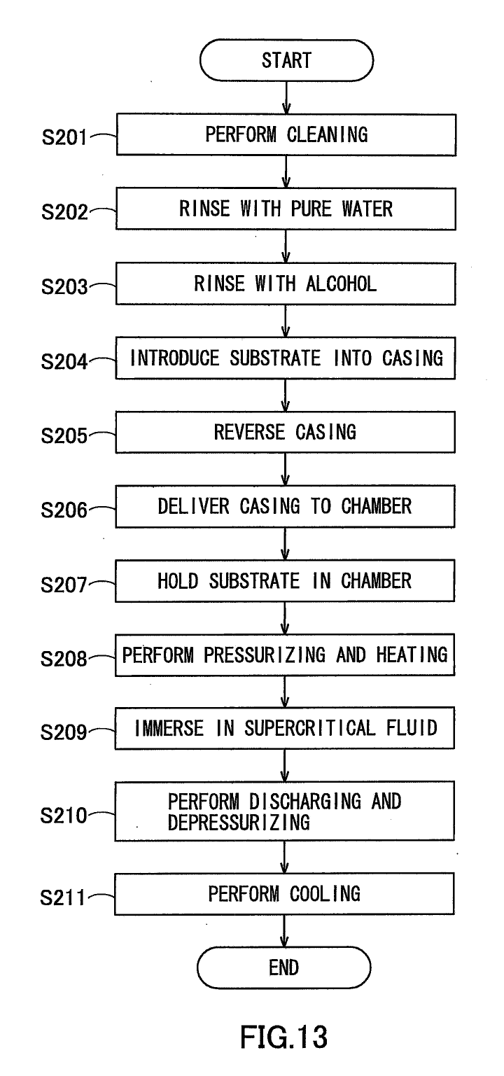

FIG. 13 is a flowchart illustrating a method of cleaning and drying the semiconductor substrate according to an embodiment of the invention. Steps S201 to S203 are similar to steps S101 to S103 of FIG. 5, and description thereof will not be repeated.

(Step S204) The semiconductor substrate is withdrawn from the cleaning chamber while the surface is wet with the IPA to prevent natural drying, and the semiconductor substrate is introduced into the casing 320 as illustrated in FIGS. 10A and 1013.

After the semiconductor substrate is introduced, the cover 321 of the casing 320 is closed. In addition, the casing 320 reserves the IPA.

(Step S205) The casing 320 which stores the semiconductor substrate is reversed (rotated by 180 degrees). As a result, the surface of the semiconductor substrate is oriented to a vertically downward direction.

(Step S206) The delivery unit 330 delivers the casing 320 to the chamber 310. The chamber 310 reserves the IPA.

(Step S207) IF the casing 320 is immersed in the IPA within the chamber 310, the cover 321 of the casing 320 is opened. The semiconductor substrate is withdrawn from the casing 320 and is held in the chamber 310 while the surface is oriented to a downward direction. In addition, the cover of the chamber 310 is closed (refer to FIGS. 12A to 12D).

(Step S208) The carbon dioxide gas within the cylinder 201 is pressurized and heated by the boost pump 204 and the heater 205 and is supplied to the chamber 310 through the pipe 301. The valve 304 is closed, and the valve 302 is opened.

If the pressure and the temperature within the chamber 310 become equal to or higher than the critical pressure and the critical temperature, respectively, of carbon dioxide, the carbon dioxide within the chamber 310 is changed to the supercritical fluid (supercritical state).

(Step S209) The semiconductor substrate is immersed in the supercritical CO₂ fluid for a predetermined time, for example, about 20 minutes. As a result, the IPA within the chamber 310 is dissolved into the supercritical CO₂ fluid and is removed from the surface (pattern surface) of the semiconductor substrate. In other words, the IPA on the pattern surface of the semiconductor substrate is substituted with the supercritical CO₂ fluid.

In this case, while the supercritical CO₂ fluid is supplied to the inside of the chamber 310 through the pipe 301, the valve 304 is opened slightly, so that the supercritical CO₂ fluid where the IPA has been dissolved is slowly discharged from the chamber 310 through the pipe 303.

(Step S210) The gas is discharged by increasing an aperture of the valve 304, and the pressure in the chamber 310 is lowered. As illustrated by the arrow A2 of FIG. 6, the carbon dioxide within the chamber 310 is changed from the supercritical state to the gaseous state as the chamber 310 is depressurized.

In this case, the liquid IPA remaining in the chamber while being dissolved into the supercritical CO₂ fluid is agglomerated and falls down to the semiconductor substrate. However, the semiconductor substrate is held by orienting the surface to a downward direction. For this reason, most of the agglomerated liquid IPA falls down to the rear surface of the semiconductor substrate, and is not almost adsorbed to the surface. Therefore, the particles can be prevented from being attached to the surface of the semiconductor substrate.

(Step S211) The semiconductor substrate is delivered to the cooling chamber (not illustrated) to perform cooling.

In this manner, according to the present embodiment, since the semiconductor substrate is delivered to the chamber 310 by orienting its surface to a downward direction in advance, even when the IPA remaining in the chamber while being dissolved into the supercritical CO₂ fluid is agglomerated and falls down to the semiconductor substrate through the discharge and depressurizing in the chamber 310, most of the IPA is attached to the rear surface of the semiconductor substrate. Therefore, the number of particles generated on the surface (pattern surface) of the semiconductor substrate can be reduced.

In addition, according to the present embodiment, since not the high-pressure casing, chamber 310, but a little light-weight casing 320 smaller than the chamber 310 is rotated, the cost of the rotational mechanism can be reduced in comparison with the first embodiment.

Although description in the first and second embodiments has been made for a case where the IPA is exemplarily used in the alcohol rinse treatment, the IPA may be substituted with ethanol, methanol, fluorinated alcohol, and the like.

Although description in the first and second embodiments has been made for a case where the semiconductor substrate is delivered to the cooling chamber different from the chambers 210 and 310, a cooling mechanism may be installed in the chamber 210 or 310 to cool the semiconductor substrate within the chambers 210 and 310.

Although description in the first and second embodiments has been made for a supercritical drying system which cyclically uses carbon dioxide, the configuration of the supercritical drying system is not limited thereto. Instead, carbon dioxide may not be cyclically used.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A supercritical drying apparatus comprising:
a chamber being hermetically sealable and configured to store a semiconductor substrate;
a heater configured to heat an inner side of the chamber;
a supply unit configured to supply carbon dioxide to the chamber;
a discharge unit configured to discharge carbon dioxide from the chamber; and
a rotation unit configured to rotate the chamber by an angle equal to or greater than 90 degrees and equal to or smaller than 180 degrees with respect to the horizontal direction.

2. The supercritical drying apparatus according to claim 1, wherein the rotation unit rotates the chamber during a period after the supply unit supplies carbon dioxide and the carbon dioxide within the chamber is changed to a supercritical state by heating by the heater and before the discharge unit discharges carbon dioxide and the carbon dioxide within the chamber is changed from a supercritical state to a gaseous state.

3. The supercritical drying apparatus according to claim 1, wherein the supply unit includes:
a first pipe having one end connected to the chamber;
a first valve provided in the first pipe;
a second pipe having one end demountably connected to the other end of the first pipe; and
a second valve provided in the second pipe, and the discharge unit includes:
a third pipe having one end connected to the chamber;
a third valve provided in the third pipe;
a fourth pipe having one end demountably connected to the other end of the third pipe; and
a fourth valve provided in the fourth pipe.

4. The supercritical drying apparatus according to claim 3, wherein the first pipe and the third pipe are formed of steel use stainless (SUS).

5. The supercritical drying apparatus according to claim 1, wherein the rotation unit rotates the chamber by 180 degrees with respect to a horizontal direction.

6. The supercritical drying apparatus according to claim 1, wherein each of the supply unit and the discharge unit includes a metal flexible pipe having one end connected to the chamber.

7. The supercritical drying apparatus according to claim 1, wherein the chamber is formed of steel use stainless (SUS).

8. A supercritical drying apparatus comprising:
a chamber being hermetically sealable and reserves a chemical solution;
a casing having an openable cover and reserves the chemical solution;
a first delivery unit delivering the semiconductor substrate having a pattern formed on a surface to a chemical solution within the casing while the surface is wet with a chemical solution;
a second delivery unit rotatably holding the casing and delivering the casing into the chamber;
a controller controlling an open/close state of the cover and rotation of the casing;
a heater heating an inner side of the chamber;
a supply unit supplying carbon dioxide to the chamber; and
a discharge unit discharging carbon dioxide from the chamber,
wherein the controller performs control such that
the cover is closed when the first delivery unit delivers the semiconductor substrate to an inner side of the casing,
the casing is reversed before the casing storing the semiconductor substrate is delivered to an inner side of the chamber,
the second delivery unit delivers the casing to an inner side of the chamber,
the cover is opened when at least a part of the casing is immersed in the chemical solution within the chamber, and
the semiconductor substrate is withdrawn from the casing.

9. The supercritical drying apparatus according to claim 8, wherein the chamber includes an inner casing for reserving a chemical solution, and
the second delivery unit delivers the semiconductor substrate to an inner side of the casing.

10. A supercritical drying method of a semiconductor substrate, comprising:
introducing the semiconductor substrate into an inner side of the chamber while a surface is wet with alcohol;
immersing the semiconductor substrate in a supercritical fluid within the chamber to substitute the alcohol on the semiconductor substrate with the supercritical fluid;
rotating the chamber by a predetermined angle equal to or greater than 90 degrees and equal to or smaller than 180 degrees with respect to a horizontal direction while the semiconductor substrate is immersed in the supercritical fluid; and
discharging the supercritical fluid and the alcohol from the chamber to depressurize the chamber while the chamber is held at the predetermined angle.

11. The supercritical drying method according to claim 10, wherein the chamber is rotated by 180 degrees with respect to a horizontal direction.

12. A supercritical drying method of a semiconductor substrate, comprising:
introducing a semiconductor substrate having a pattern formed on a surface into a chamber while the surface is wet with alcohol and is oriented to a vertically downward direction;
immersing the semiconductor substrate in a supercritical fluid within the chamber to substitute the alcohol on the semiconductor substrate with the supercritical fluid; and
discharging the supercritical fluid and the alcohol from the chamber to depressurize the chamber.

13. The supercritical drying method according to claim 12, further comprising:
delivering the semiconductor substrate to an inner side of the casing which reserves the alcohol by orienting the surface to a vertically upward direction;
reversing the casing storing the semiconductor substrate;
delivering the reversed casing to an inner side of the chamber; and
moving the semiconductor substrate from the casing to the chamber.
